(19) United States
(12) Patent Application Publication
(10) Pub. No.: US 2020/0351135 A1
(43) Pub. Date: Nov. 5, 2020

(54) RADIO TRANSMISSION APPARATUS AND RADIO RECEPTION APPARATUS

(71) Applicant: NTT DOCOMO, INC., Tokyo (JP)

(72) Inventors: Hideyuki Moroga, Tokyo (JP); Keisuke Saito, Tokyo (JP); Satoshi Nagata, Tokyo (JP); Yuichi Kakishima, Tokyo (JP)

(73) Assignee: NTT DOCOMO, INC., Tokyo (JP)

(21) Appl. No.: 16/764,945

(22) PCT Filed: Nov. 21, 2017
(86) PCT No.: PCT/JP2017/041908

§ 371 Date: May 18, 2020

(51) Int. Cl. H04L 27/26; H04L 27/20; H04W 72/12; H04W 72/04; H04L 5/00

(52) U.S. Cl. CPC H04L 27/2613; H04L 27/201; H04L 5/0051; H04W 72/0446; H04W 72/1263

(57) ABSTRACT

A radio transmission apparatus may include transmission section (105) that transmits a radio link signal, and control section (101). The radio link signal includes a phase variation correction reference signal used for correction of phase variation in a propagation channel in some cases. Control section (101) controls whether to map the phase variation correction reference signal to the radio link signal, or controls a mapping interval of the phase variation correction reference signal in the radio link signal, based on a time length or a type (Non-slot-based type or not) of a slot as a resource allocation unit.

### TECHNICAL FIELD

The present invention relates to a radio transmission apparatus and a radio reception apparatus.

### BACKGROUND ART

Long Term Evolution (LTE) has been specified for achieving a higher data rate, lower latency, and the like in a Universal Mobile Telecommunications System (UMTS) network (see Non-Patent Literature (hereinafter referred to as “NPL”) 1). Successor systems of LTE have also been studied for achieving a broader bandwidth and a higher speed based on LTE. Examples of successor systems of LTE include the systems called LTE-Advanced (LTE-A), Future Radio Access (FRA), 5th generation mobile communication system (5G), 5G plus (5G+), New Radio Access Technology (New-RAT)), and the like.

Supporting a wide range of frequencies from a low carrier frequency to a high carrier frequency is expected for the future radio communication system (for example, 5G). For example, propagation channel environment and/or a request condition are largely different depending on a frequency band such as a low carrier frequency and a high carrier frequency. Therefore, it is desirable to flexibly support arrangement (mapping) of a reference signal (RS) for the future radio communication system.

Further, in the future radio communication system, resource allocation is performed in units of a resource unit (RU). The RU is based on a so-called “Slot-based” resource allocation in which 168 resource elements (REs) are arranged by 14 pieces in a time direction and by 12 pieces in a frequency direction. In other words, the RU in the Slot-based resource allocation includes 14 symbols and 12 subcarriers. Note that the RU is also called a resource block or a resource block pair. Further, the RU may be referred to as “slot”.

Moreover, in the future radio communication system, the RU may be based on a so-called “Non-slot-based” resource allocation in which REs include symbols within a range from one symbol to 14 symbols and 12 subcarriers.

### CITATION LIST

### Non-Patent Literature

### NPL 1

3GPP TS 36.300 v13.4.0, “Evolved Universal Terrestrial Radio Access (E-UTRA) and Evolved Universal Terrestrial Radio Access Network (E-UTRAN); Overall description; Stage 2 (Release 13),” June 2016

### SUMMARY OF INVENTION

### Technical Problem

In the future radio communication system, mapping of an RS referred to as a Phase Tracking Reference Signal (PTRS) is defined in order to correct phase variation by phase noise caused by an oscillator or the like in a high-frequency band. Note that “correction” of the phase variation may be also called “rectification” or “compensation”.

A mapping interval (or insertion density) of the PTRS in the Slot-based resource allocation in the frequency direction and the time direction is determined in the future radio communication system. In contrast, the configuration of the PTRS in the Non-Slot-based resource allocation is not determined. Accordingly, in a case where the PTRS is configured in the Non-slot-based resource allocation in a manner similar to the Slot-based resource allocation, the configuration of the PTRS may not become appropriate. For example, if the number of PTRSs is insufficient, the phase variation cannot be sufficiently corrected, and the expected signal quality cannot be obtained. In contrast, if the number of PTRSs becomes excessive, overhead increases and throughput is deteriorated.

An object of the present invention is to prevent deterioration of quality of a radio link signal due to phase noise and to prevent deterioration of throughput due to increase of overhead, by achieving the appropriate PTRS configuration in the Non-slot-based resource allocation.

### Solution to Problem

A radio transmission apparatus according to one aspect of the present invention includes: a transmission section that transmits a radio link signal; and a control section that controls whether to map a phase variation correction reference signal to the radio link signal or controls a mapping interval of the phase variation correction reference signal in the radio link signal, based on a time length or a type of a resource allocation unit.

### Advantageous Effects of Invention

According to one aspect of the present invention, the appropriate PTRS configuration is achieved in the Non-Slot-based resource allocation. This makes it possible to prevent deterioration of quality of the radio link signal due to phase noise and to prevent deterioration of throughput due to increase of overhead.

### BRIEF DESCRIPTION OF DRAWINGS

FIG. 1 is a block diagram illustrating an exemplary entire configuration of a radio base station according to an embodiment;

FIG. 2 is a block diagram illustrating an exemplary entire configuration of a user terminal according to an embodiment;

FIGS. 3A to 3C illustrate a first example of a PTRS mapping control method according to an embodiment;

FIGS. 4A to 4C illustrate a second example of the PTRS mapping control method according to an embodiment;

FIGS. 5A to 5C illustrate a third example of the PTRS mapping control method according to an embodiment; and

FIG. 6 illustrates an exemplary hardware configuration of a radio base station and a user terminal according to an embodiment.

### DESCRIPTION OF EMBODIMENTS

Hereinafter, an embodiment of the present invention will be described in detail with reference to the accompanying drawings.

### Embodiment

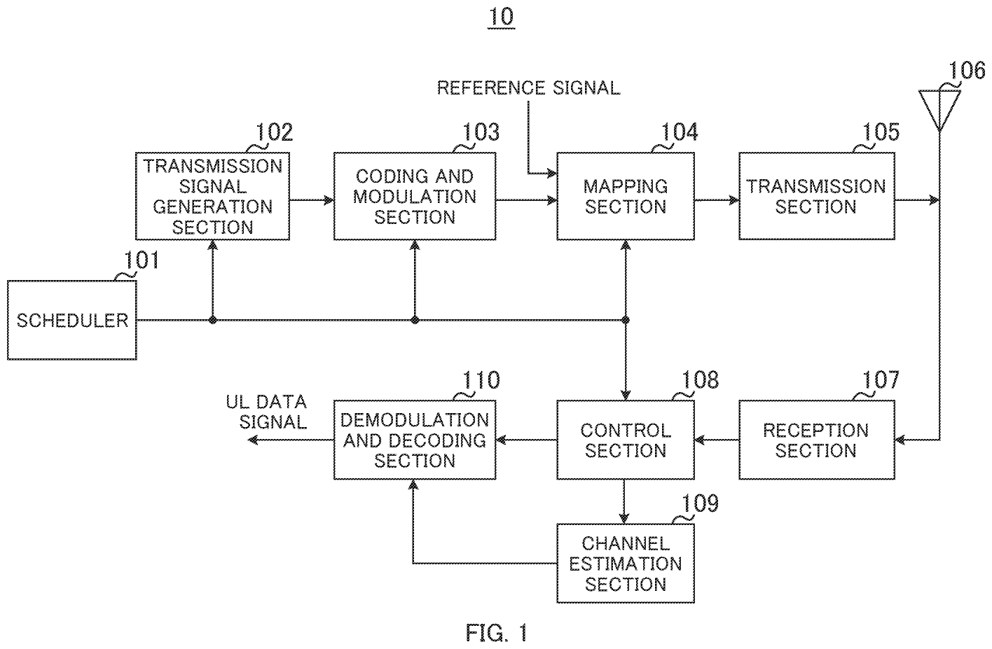

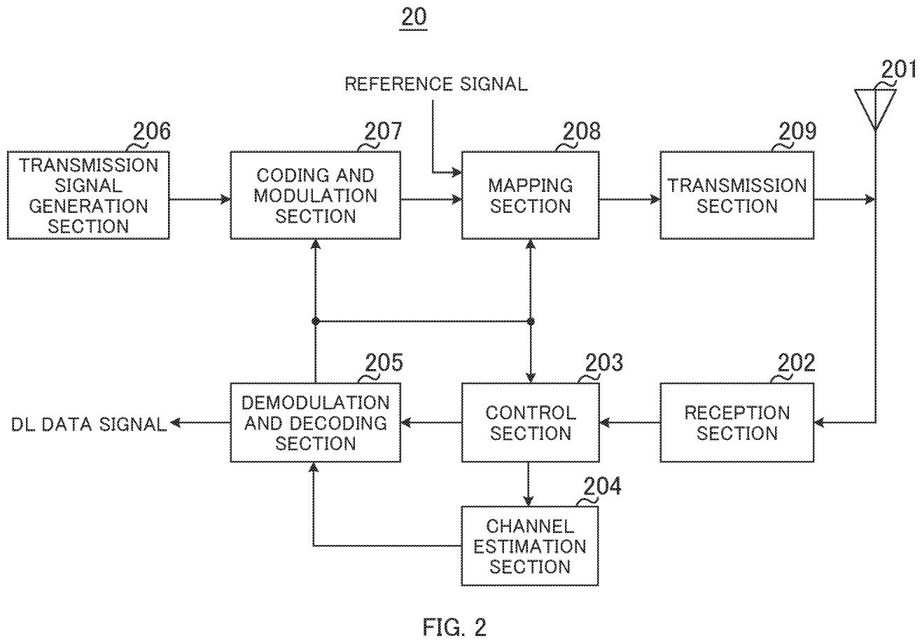

A radio communication system according to the present embodiment includes radio base station 10 (for example, also called eNodeB (eNB) or gNodeB (gNB)) illustrated in FIG. 1, and user terminal 20 (for example, also called User Equipment (UE)) illustrated in FIG. 2. User terminal 20 is wirelessly connected to (wirelessly accesses) radio base station 10. In other words, radio link is formed between radio base station 10 and user terminal 20.

A radio signal propagating through the radio link may be referred to as a radio link signal. The radio link in a direction from radio base station 10 to user terminal 20 may be referred to as Downlink (DL). Accordingly, the radio link signal transmitted from radio base station 10 to user terminal 20 may be referred to as a DL signal. In contrast, a radio link transmitted from user terminal 20 to radio base station 10 may be referred to as Uplink (UL). Accordingly, a radio link signal transmitted from user terminal 20 to radio base station 10 may be referred to as an UL signal.

Radio base station 10 transmits the DL control signal to user terminal 20 through a DL control channel (for example, Physical Downlink Control Channel (PDCCH)). In addition, radio base station 10 transmits a DL data signal and a Demodulation Reference Signal to user terminal 20 through a DL data channel (for example, Physical Downlink Shared Channel (PDSCH)). The demodulation reference signal is a signal used for demodulation of the DL data signal. In the following, the demodulation reference signal is appropriately described as a DMRS. Further, radio base station 10 transmits the PTRS to user terminal 20 through the DL data channel in a predetermined case.

In addition, user terminal 20 transmits a UL control signal to radio base station 10 through a UL control channel (for example, Physical Uplink Control Channel (PUCCH)) or a UL data channel (for example, Physical Uplink Shared Channel (PUSCH)). Further, user terminal 20 transmits a UL data signal and the DMRS to radio base station 10 through a UL data channel (for example, Physical Uplink Shared Channel (PUSCH)). In addition, user terminal 20 transmits the PTRS to radio base station 10 through the UL data channel in a predetermined case.

In the radio communication system according to the present embodiment, as an example, two types of DMRS mapping patterns (Configuration types 1 and 2) are supported. In the radio communication system according to the present embodiment, various DMRS mapping methods are supported. The DMRS mapping methods include, for example, a mapping method of performing frequency multiplexing of the DMRS and the data signal, and a mapping method of multiplexing the DRMSs of different ports.

Note that, in the radio communication system according to the present embodiment, a front-loaded DMRS may be used as an example of the DMRS. The front-loaded DMRS is mapped to front side of the slot in a time direction. Mapping the front-loaded DMRS to the front side makes it possible to reduce a processing time necessary for channel estimation and the demodulation processing in the radio communication system.

Further, the downlink channel and the uplink channel through which radio base station 10 and user terminal 20 perform transmission and reception are not limited to the PDCCH, the PDSCH, the PUCCH, and the PUSCH described above. The downlink channel and the uplink channel through which radio base station 10 and user terminal 20 perform transmission and reception may be other channels such as a Physical Broadcast Channel (PBCH) and a Random Access Channel (RACH).

In addition, in FIG. 1 and FIG. 2, a waveform of the DL signal and/or the UL signal generated in radio base station 10 and user terminal 20 may be a signal waveform based on Orthogonal Frequency Division Multiplexing (OFDM). Alternatively, a waveform of the DL signal and/or the UL signal may be a signal waveform based on Single Carrier-Frequency Division Multiple Access (SC-FDMA) or DFT-Spread-OFDM (DFT-S-OFDM). Alternatively, a waveform of the DL signal and/or the UL signal may be any other signal waveform. In FIG. 1 and FIG. 2, illustration of constituent sections for generation of the signal waveform (for example, IFFT processing section, CP addition section, CP removal section, and FFT processing section) is omitted.

<Radio Base Station>

FIG. 1 is a block diagram illustrating an exemplary entire configuration of radio base station 10 according to the present embodiment. Radio base station 10 includes scheduler 101, transmission signal generation section 102, coding and modulation section 103, mapping section 104, transmission section 105, antenna 106, reception section 107, control section 108, channel estimation section 109, and demodulation and decoding section 110. Radio base station 10 may include a Multi-User Multiple-Input Multiple-Output (MU-MIMO) configuration that performs communication with plurality of user terminals 20 at the same time. Alternatively, radio base station 10 may include a Single-User Multiple-Input Multiple-Output (SU-MIMO) configuration that performs communication with one user terminal 20. Alternatively, radio base station 10 may include both of the SU-MIMO configuration and the MU-MIMO configuration.

Scheduler 101 performs scheduling (for example, resource allocation and port allocation) of the DL signals (such as DL data signal, DL control signal, DMRS, and PTRS). In addition, scheduler 101 performs scheduling (for example, resource allocation and port allocation) of the UL signals (such as UL data signal, UL control signal, DMRS, and PTRS).

In the scheduling, scheduler 101 selects configuration of a mapping pattern representing resource elements to which the DMRS of the DL signal is mapped, from “Configuration type 1” or “Configuration type 2”. For example, scheduler 101 selects one mapping pattern from Configuration type 1 or Configuration type 2 based on propagation path environment (for example, communication quality and frequency selectivity), and/or a request condition (for example, moving speed of supported terminal), and/or performance of radio base station 10 or user terminal 20. Alternatively, the mapping pattern may be previously determined.

As described below, scheduler 101 may be regarded as a control section that controls whether to map the PTRS to the radio link signal or controls a mapping interval of the PTRS in the radio link signal, based on the time length or the type (Non-slot-based resource allocation or not) of the slot.

Further, scheduler 101 outputs scheduling information to transmission signal generation section 102 and mapping section 104.

Further, scheduler 101 configures Modulation and Coding scheme (MCS such as coding rate and modulation scheme) of the DL data signal and the UL data signal based on, for example, channel quality between radio base station 10 and user terminal 20. Scheduler 101 outputs the configured MCS information to transmission signal generation section 102 and coding and modulation section 103. Note that the MCS may be configured by user terminal 20 without limitation to radio base station 10. In a case where user terminal 20 configures the MCS, radio base station 10 can receive the MCS information from user terminal 20 (not illustrated).

Transmission signal generation section 102 generates a transmission signal (including DL data signal and DL control signal). For example, the DL control signal includes Downlink Control Information (DCI) including the scheduling information (for example, configuration information) or the MCS information output from scheduler 101. Transmission signal generation section 102 outputs the generated transmission signal to coding and modulation section 103.

Coding and modulation section 103 performs coding processing and modulation processing on the transmission signal provided from transmission signal generation section 102 based on, for example, the MCS information provided from scheduler 101. Coding and modulation section 103 outputs a modulated transmission signal to mapping section 104.

Mapping section 104 maps the transmission signal provided from coding and modulation section 103 to radio resources (DL resources) based on the scheduling information (for example, DL resource allocation) provided from scheduler 101. Further, mapping section 104 maps the DMRS and the PTRS to radio resources (DL resources) based on the scheduling information. Mapping section 104 outputs the DL signal mapped to the radio resources to transmission section 105.

Transmission section 105 performs transmission processing such as upconversion and amplification on the DL signal provided from mapping section 104, and transmits a radio frequency signal (DL signal) from antenna 106.

Reception section 107 performs reception processing such as amplification and downconversion on a radio frequency signal (UL signal) received by antenna 106, and outputs the UL signal to control section 108. The UL signal may include the UL data signal, the DMRS, and the PTRS.

Control section 108 separates (demaps) the UL data signal, the DMRS, and the PTRS from the UL signal provided from reception section 107 based on the scheduling information (for example, UL resource allocation information) provided from scheduler 101. Further, control section 108 outputs the UL data signal to demodulation and decoding section 110, and outputs the DMRS and the PTRS to channel estimation section 109.

Channel estimation section 109 performs channel estimation with use of the DMRS of the UL signal, and outputs a channel estimation value as a result of the estimation to demodulation and decoding section 110. Further, channel estimation section 109 performs channel estimation with use of, for example, the PTRS of the UL signal, calculates a difference between channel estimation values of the respective symbols to calculate a phase variation amount of each of the symbols, and outputs the phase variation amount to demodulation and decoding section 110.

Demodulation and decoding section 110 performs demodulation processing and decoding processing on the UL data signal provided from control section 108 based on the channel estimation value or both of the channel estimation value and the phase variation amount provided from channel estimation section 109. For example, demodulation and decoding section 110 corrects the channel estimation value of the subcarriers of Resource Elements (REs) to which the UL data signal to be demodulated is mapped, with use of a time variation amount of the symbol of the REs. Further, demodulation and decoding section 110 multiplies, for example, the signal to be demodulated by a reciprocal of the corrected channel estimation value to perform channel compensation (equalization processing), thereby demodulating the channel-compensated UL data signal. Further, demodulation and decoding section 110 transfers the demodulated decoded UL data signal to an application section (not illustrated). Note that the application section performs processing relating to a layer higher than a physical layer or a MAC layer, and the like.

A block including scheduler 101, transmission signal generation section 102, coding and modulation section 103, mapping section 104, and transmission section 105 may be regarded as an example of a radio transmission apparatus provided in radio base station 10. Further, a block including reception section 107, control section 108, channel estimation section 109, and demodulation and decoding section 110 may be regarded as an example of a radio reception apparatus provided in radio base station 10.

Further, as described below, a block including control section 108, channel estimation section 109, and demodulation and decoding section 110 may be regarded as an example of a processing section that performs reception processing on the DL signal with use of the PTRS mapped to the time domain based on a reference position of the DL signal in the time domain.

<User Terminal>

FIG. 2 is a block diagram illustrating an exemplary entire configuration of user terminal 20 according to the present embodiment. User terminal 20 includes antenna 201, reception section 202, control section 203, channel estimation section 204, demodulation and decoding section 205, transmission signal generation section 206, coding and modulation section 207, mapping section 208, and transmission section 209.

Reception section 202 performs reception processing such as amplification and downconversion on a radio frequency signal (DL signal) received by antenna 201, and outputs the DL signal to control section 203. The DL signal may include a DL data signal, a DMRS, and a PTRS.

Control section 203 separates (demaps) the DL control signal, the DMRS, and the PTRS from the DL signal provided from reception section 202. Further, control section 203 outputs the DL control signal to demodulation and decoding section 205, and outputs the DMRS and the PTRS to channel estimation section 204.

Control section 203 controls the reception processing for the DL signal. Further, control section 203 separates (demaps) the DL data signal from the DL signal based on the scheduling information (for example, DL resource allocation information) provided from demodulation and decoding section 205, and outputs the DL data signal to demodulation and decoding section 205.

Channel estimation section 204 performs channel estimation with use of the DMRS separated from the DL signal, and outputs a channel estimation value as a result of the estimation to demodulation and decoding section 205. Further, channel estimation section 204 performs channel estimation with use of, for example, the PTRS of the DL signal, and calculates a difference between the channel estimation values of the respective symbols to calculate a phase variation amount of each of the symbols, and outputs the phase variation amount to demodulation and decoding section 205.

Demodulation and decoding section 205 demodulates the DL control signal provided from control section 203. Further, demodulation and decoding section 205 performs decoding processing (for example, blind detection processing) on the demodulated DL control signal. Demodulation and decoding section 205 outputs the scheduling information (for example, DL/UL resource allocation information) addressed to the own terminal that has been obtained through decoding of the DL control signal, to control section 203 and mapping section 208, and outputs the MCS information for the UL data signal to coding and modulation section 207.

Further, demodulation and decoding section 205 performs demodulation processing and decoding processing using the channel estimation value or both of the channel estimation value and the phase variation amount provided from channel estimation section 204, on the DL data signal provided from control section 203, based on the MCS information for the DL data signal included in the DL control signal provided from control section 203.

For example, demodulation and decoding section 205 corrects the channel estimation value of the subcarriers of the REs to which the DL data signal to be demodulated is mapped, with use of a time variation amount of the symbol of the REs. Further, demodulation and decoding section 205 multiplies, for example, the signal to be demodulated by a reciprocal of the corrected channel estimation value to perform channel compensation (equalization processing), thereby demodulating the channel-compensated DL data signal.

Further, demodulation and decoding section 205 transfers the demodulated decoded DL data signal to an application section (not illustrated). Note that the application section performs processing relating to a layer higher than a physical layer or a MAC layer, and the like.

Transmission signal generation section 206 generates a transmission signal (including UL data signal or UL control signal), and outputs the generated transmission signal to coding and modulation section 207.

Coding and modulation section 207 performs coding processing and modulation processing on the transmission signal provided from transmission signal generation section 206 based on, for example, the MCS information provided from demodulation and decoding section 205. Coding and modulation section 207 outputs the modulated transmission signal to mapping section 208.

Mapping section 208 maps the transmission signal provided from coding and modulation section 207 to radio resources (UL resources) based on the scheduling information (UL resource allocation) provided from demodulation and decoding section 205. Further, mapping section 208 maps the DMRS and the PTRS to radio resources (UL resources) based on the scheduling information.

Mapping of the DMRS and the PTRS to the radio resources may be controlled by, for example, control section 203. For example, as described below, control section 203 may be regarded as an example of a control section that controls whether to map the PTRS to the radio link signal or controls the mapping interval of the PTRS in the radio link signal, based on the time length or the type (Non-slot-based resource allocation or not) of the slot.

Transmission section 209 performs transmission processing such as upconversion and amplification on the UL signal (at least including UL data signal and DMRS) provided from mapping section 208, and transmits a radio frequency signal (UL signal) from antenna 201.

A block including transmission signal generation section 206, coding and modulation section 207, mapping section 208, and transmission section 209 may be regarded as an example of a radio transmission apparatus provided in user terminal 20. Further, a block including reception section 202, control section 203, channel estimation section 204, and demodulation and decoding section 205 may be regarded as an example of a radio reception apparatus provided in user terminal 20.

(PTRS Mapping Control Method)

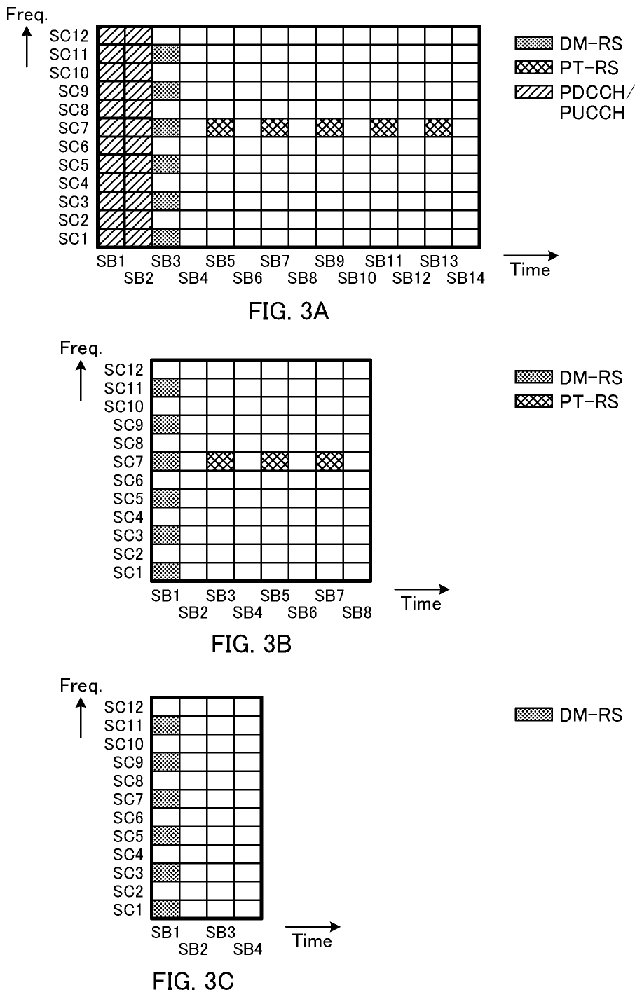

In the following, the PTRS mapping control method is described with reference to FIG. 3A to FIG. 5C. Note that, in the following description, 14 symbols of one slot in the time direction are also referred to as SB1 to SB14 from left. Further, 12 subcarriers of one slot in the frequency direction are also referred to as SC1 to SC12 from below.

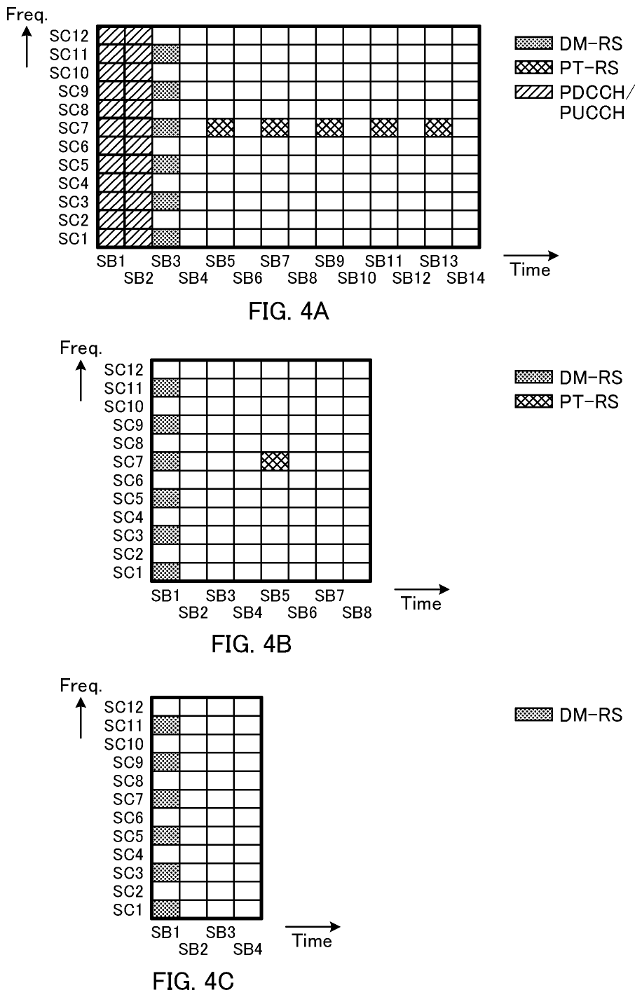

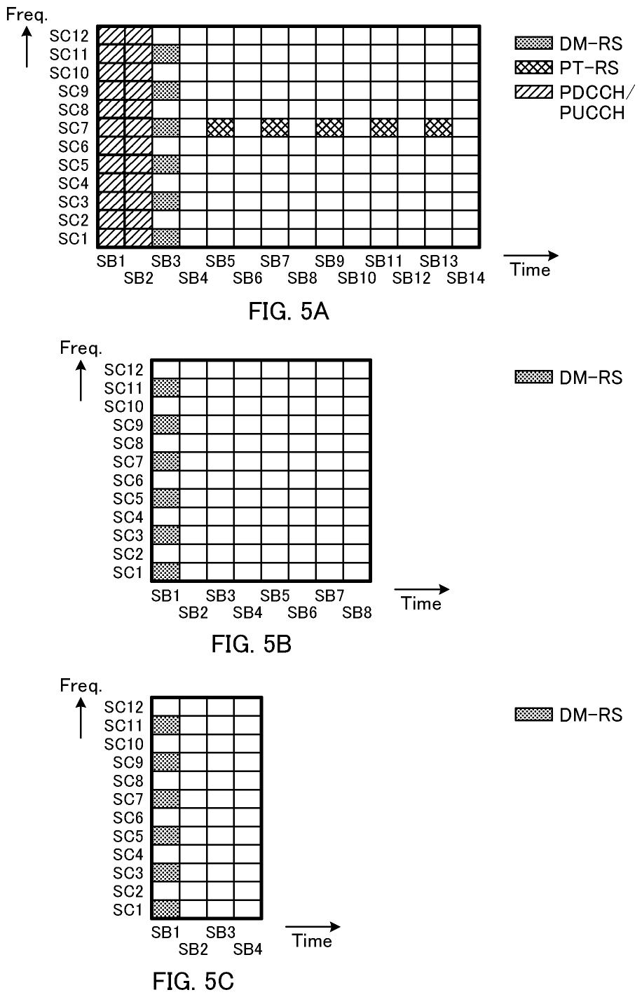

FIGS. 3A to 3C illustrate a first example of the PTRS mapping control method. FIGS. 4A to 4C illustrate a second example of the PTRS mapping control method. FIGS. 5A to 5C illustrate a third example of the PTRS arrangement control method.

FIG. 3A, FIG. 4A, and FIG. 5A each illustrate a slot of the Slot-based resource allocation. Note that, in the example of these figures, the signal of the control channel (for example, PDCCH or PUCCH) is mapped to the REs in the head two symbols (SB1 and SB2) of each of the subcarriers of one slot. Note that, in these figures, the number of symbols of the control channel is not limited to two, and may be one or three.

Further, in the example of these figures, the DMRS is mapped to the RE in a third symbol (SB3) in each of odd-numbered subcarriers SC1, SC3, SC5, SC7, SC9, and SC11. Note that, in these figures, the position to which the DMRS is mapped is not limited to the third symbol (SB3), and may be, for example, a fourth symbol and a fifth symbol (SB4 and SB5). For example, in the case of UL, the DMRS may be mapped to the head of the symbol to which the PUSCH is mapped. Further, the number of symbols to which the DMRS is mapped is not limited to one. For example, the DMRS may be mapped to two symbols in one slot. For example, the DMRS may be mapped to the third symbol (SB3) and the fourth symbol (SB4) in one slot.

FIG. 3B, FIG. 4B, and FIG. 5B each illustrate a slot of a Non-slot-based resource allocation with eight symbols, and FIG. 3C, FIG. 4C, and FIG. 5C each illustrate a slot of a Non-slot-based resource allocation with four symbols. In the example of these figures, the DMRS is mapped to the RE in the head symbol (SB1) in each of the odd-numbered subcarriers SC1, SC3, SC5, SC7, SC9, and SC11 in one slot. Note that, in these figures, the control channel may be mapped. Further, in these figures, the position to which the DMRS is mapped is not limited to the head symbol (SB1), and may be, for example, the second symbol (SB2).

In a case where the slot of the Slot-based resource allocation and the slot of the Non-slot-based resource allocation are dynamically switched, and in a case where the slot length of the Non-slot-based resource allocation is dynamically switched, radio base station 10 may notify the switching through the DPCCH.

(First Example of PTRS Mapping Control Method)

First, the first example of the PTRS mapping control method is described with reference to FIGS. 3A to 3C. In the first example, radio base station 10 controls execution/inexecution of the PTRS mapping based on the slot length (number of symbols). More specifically, radio base station 10 performs control so as to map the PTRS when the slot length is equal to or greater than threshold X, and not to map the PTRS when the slot length is lower than threshold X. For example, in a case of X=5, radio base station 10 maps the PTRS to the slot of the Slot-based resource allocation with 14 symbols illustrated in FIG. 3A and the slot of the Non-slot-based resource allocation with 8 symbols illustrated in FIG. 3B, but does not map the PTRS to the slot of the Non-slot-based resource allocation with four symbols illustrated in FIG. 3C.

In the example of FIG. 3A, the PTRS is mapped on rear side at a rate of one RE per two symbols based on the RE in SB3 of SC7 to which the DMRS is mapped. In other words, in the example of FIG. 3A, the PTRS is mapped to the RE in each of SB5, SB7, SB9, SB11, and SB13 of SC7.

In the example of FIG. 3B, the PTRS is mapped on rear side at a rate of one RE per two symbols based on the RE of SB1 of SC7 to which the DMRS is mapped. In other words, in the example of FIG. 3B, the PTRS is mapped to the RE in each of SB3, SB5, and SB7 of SC7.

In the example of FIG. 3C, the PTRS is not mapped to any of REs.

Note that, in the examples of FIG. 3A to FIG. 3C, the PTRS is mapped in SC7 in the time direction. This is illustrative, and the PTRS may be mapped to one or more of 12 subcarriers SC1 to SC12 in the time direction. The same applies to the accompanying drawings used in the following description.

Further, in the examples of FIG. 3A to FIG. 3C, the signal of the data channel (for example, PDSCH or PUSCH) may be mapped to the REs to which the control channel, the DMRS, and the PTRS are not mapped. The same applies to the accompanying drawings used in the following description.

Threshold X may be determined by radio base station 10, based on an average received power (RSRP), average reception quality (RSRQ), and channel quality (CQI) that are reported from user terminal 20, the channel estimation value estimated by radio base station 10, or the like.

Radio base station 10 notifies user terminal 20 of threshold X. Radio base station 10 may explicitly or implicitly notify threshold X.

For example, in a case where threshold X is explicitly notified, radio base station 10 may notify threshold X with use of Downlink Control Information (DCI) of the physical control channel. Further, radio base station 10 may notify threshold X through higher layer signaling such as Radio Resource Control (RRC) signaling and Medium Access Control (MAC) signaling. Alternatively, radio base station 10 may notify threshold X with use of broadcast information such as Master Information Block (MIB) and System Information Block (SIB).

In contrast, in a case where threshold X is implicitly notified, radio base station 10 and user terminal 20 may associate the configuration of a Synchronization Signal (SS), PBCH, SIB, or RACH, with threshold X in one to one. As a result, threshold X is implicitly notified by an existing signal. This eliminates new signaling for notification of threshold X, which makes it possible to reduce overhead.

Although, in the above description, the example in which the control is performed so as to map the PTRS when the slot length is equal to or greater than threshold X and so as not to map the PTRS when the slot length is lower than threshold X has been described, the present embodiment is not limited to the example. For example, the control may be performed so as not to map the PTRS when the slot length is equal to or greater than threshold X and so as to map the PTRS when the slot length is lower than threshold X.

Although, in the above description, the example in which execution/inexecution of the mapping of the PTRS is controlled based on magnitude relationship between the slot length including the symbols to which the control channel is mapped and threshold X has been described, the present embodiment is not limited to the example. For example, execution/inexecution of the mapping of the PTRS may be controlled based on magnitude relationship between the slot length (12 symbols in example of FIG. 3A) excluding the symbols to which the control channel is mapped and threshold X.

(Second Example of PTRS Mapping Control Method)

Next, the second example of the PTRS mapping control method is described with reference to FIGS. 4A to 4C. In the second example, radio base station 10 controls a mapping interval (insertion density) of the PTRS based on the slot length (number of symbols). More specifically, radio base station 10 performs control so as to map the PTRS at density Y1 when the slot length is equal to or greater than threshold X1, to map the PTRS at density Y2 (Y2<Y1) when the slot length is lower than threshold X1 and is equal to or greater than threshold X2, and to map (or not to map) the PTRS at density Y3 (Y3<Y2) when the slot length is lower than threshold X2. For example, in a case where X1=10, X2=5, Y1=½, Y2=¼, and Y3=0 (=no PTRS), radio base station 10 maps the PTRS to the slot of the Slot-based resource allocation with 14 symbols illustrated in FIG. 4A at a rate of one RE per two symbols, and maps the PTRS to the slot of the Non-slot-based resource allocation with eight symbols illustrated in FIG. 4B at a rate of one RE per four symbols, and does not map the PTRS to the slot of the Non-slot-based resource allocation with four symbols illustrated in FIG. 4C.

In the example of FIG. 4A, the PTRS is mapped on rear side at a rate of one RE per two symbols based on the RE in SB3 of SC7 to which the DMRS is mapped. In other words, in the example of FIG. 4A, the PTRS is mapped to the RE in each of SB5, SB7, SB9, SB11, and SB13 of SC7.

In the example of FIG. 4B, the PTRS is mapped on rear side at a rate of one RE per four symbols based on the RE in SB1 of SC7 to which the DMRS is mapped. In other words, in the example of FIG. 4B, the PTRS is mapped to the RE in SB5 of SC7.

In the example of FIG. 4C, the PTRS is not mapped to any of REs.

Each of thresholds (X1 and X2) and densities (Y1, Y2, and Y3) may be determined by radio base station 10, based on an average received power (RSRP), average reception quality (RSRQ), and channel quality (CQI) that are reported from user terminal 20, the channel estimation value estimated by radio base station 10, or the like. Further, at least one of thresholds (X1 and X2) and densities (Y1, Y2, and Y3) may be previously determined by specification.

In a case where radio base station 10 determines thresholds (X1 and X2) and densities (Y1, Y2, and Y3), radio base station 10 notifies user terminal 20 of the determined values. Note that, as with the notification of threshold X described in the first example, radio base station 10 may explicitly or implicitly notify the determined values.

Although, in the above description, the example of two thresholds (X1 and X2) has been described, the present embodiment is not limited to the example, and the number of thresholds may be three or more. In this case, the number of densities becomes “the number of thresholds+1”. For example, in a case of three thresholds (X1, X2, and X3), radio base station 10 performs control so as to map the PTRS at density Y1 when the slot length is equal to or greater than threshold X1, to map the PTRS at density Y2 (Y2<Y1) when the slot length is lower than threshold X1 and is equal to or greater than threshold X2, to map the PTRS at density Y3 (Y3<Y2) when the slot length is lower than threshold X2 and is equal to or greater than threshold X3, and to map (or not to map) the PTRS at density Y4 (Y4<Y3) when the slot length is lower than threshold X3.

Although, in the above description, the example in which the mapping interval (insertion density) of the PTRS is controlled in the time direction has been described, the present embodiment is not limited to the example, and the mapping interval (insertion density) of the PTRS may be controlled in the frequency direction. For example, in a case where 12 resource blocks (RBs=slot) are allocated to user terminal 20 in the frequency direction and X1=10, X2=5, Y1=½, Y2=¼, and Y3=0 (=no PTRS), radio base station 10 performs controls so as to map the PTRS to the slot of the Slot-based resource allocation with 14 symbols at a rate of one RE per two RBs, to map the PTRS to the slot of Non-slot-based resource allocation with eight symbols at a rate of one RE per four RBs, and not to map the PTRS to the slot of Non-slot-based resource allocation with four symbols.

Although, in the above description, the example in which the control is performed so as to make the mapping interval of the PTRS stepwisely denser as the slot length increases has been described, the present embodiment is not limited to the example. For example, the control may be performed so as to make the mapping interval of the PTRS stepwisely sparser as the slot length increases.

Although, in the above description, the example in which the density is stepwisely controlled with the plurality of thresholds has been described, the present embodiment is not limited to the example. For example, the density of the PTRS or the mapping pattern of the PTRS may be configured depending on the slot length. For example, 14 mapping patterns respectively corresponding to 1 symbol to 14 symbols may be configured.

Further, in the present embodiment, the existing densities of the PTRS of the Slot-based resource allocation may be reused as values of the densities Y1, Y2, Y3, and the like.

Although, in the above description, the number of symbols has been configured as the parameter determining the density of the PTRS, the present embodiment is not limited thereto. For example, a combination with the MCS may be used as a threshold. In this case, in addition to the number of symbols, the density of the PTRS may be determined based on whether the value of the MCS is lower than Z1, is Z1 or more and less than Z2, is equal to or larger than Z2, or the like.

(Third Example of PTRS Mapping Control Method)

Next, the third example of the PTRS mapping control method is described with reference to FIGS. 5A to 5C. In the third example, radio base station 10 controls execution/inexecution of the mapping of the PTRS for each of the slot of the Slot-based resource allocation and the slot of the Non-slot-based resource allocation. For example, as illustrated in FIGS. 5A to 5C, radio base station 10 performs control so as to map the PTRS to the slot of the Slot-based resource allocation, and not to map the PTRS to the slot of the Non-slot-based resource allocation.

In the example of FIG. 5A, the PTRS is mapped on rear side at a rate of one RE per two symbols based on the RE in SB3 of SC7 to which the DMRS is mapped. In other words, in the example of FIG. 5A, the PTRS is mapped to the RE in each of SB5, SB7, SB9, SB11, and SB13 of SC7.

In the examples of FIG. 5B and FIG. 5C, the PTRS is not mapped to any of REs.

Information indicating execution (ON)/inexecution (OFF) of the mapping of the PTRS (hereinafter, referred to as “ON/OFF information”) for each of the slot of the Slot-based resource allocation and the slot of the Non-slot-based resource allocation may be determined based on an average received power (RSRP), average reception quality (RSRQ), and channel quality (CQI) that are reported from user terminal 20, the channel estimation value estimated by radio base station 10, or the like.

Radio base station 10 notifies user terminal 20 of the ON/OFF information. Note that, as with notification of threshold X described in the first example, radio base station 10 may explicitly or implicitly notifies the ON/OFF information.

### Effects

As described above, in the present embodiment, execution/inexecution of the mapping of the PTRS is controlled based on the magnitude relationship between the time length of the slot as the resource allocation unit and the threshold, as described in the first example. In addition, the mapping interval of the PTRS is controlled based on the time length of the slot, as described in the second example. Further, execution/inexecution of the mapping of the PTRS is controlled based on the type of the slot (Non-slot-based resource allocation or not), as described in the third example. Performing any of these controls makes it possible to achieve the appropriate PTRS configuration of the Non-slot-based resource allocation. Accordingly, in the Non-slot-based resource allocation, it is possible to prevent quality deterioration of the radio link signal due to phase noise, and to prevent deterioration of throughput due to increase of overhead.

### Terms

The slot may be called a mini-slot, a non-slot, or a sub-slot. Further, the slot length may be called a mini-slot length, a non-slot length, or a sub-slot length.

The PDCCH may be called a downlink control channel, or an s-PDCCH. The PDSCH may be called a downlink data channel, or an s-PDSCH. The PUSCH may be called an uplink data channel, or an s-PUSCH. The PUCCH may be called an uplink control channel, or an s-PUCCH.

The DMRS may be called a demodulation RS, or an s-DMRS. The PTRS may be called a phase variation correction RS or an s-PTRS.

Although the example of the downlink has been described in the above-described description, the present invention is applicable not only to the downlink but also to the uplink.

The embodiment of the present invention has been described above.

(Hardware Configuration)

Note that the block diagrams used to describe the embodiments illustrate blocks on the basis of functions. These functional blocks (constituent sections) are implemented by any combination of hardware and/or software. A means for implementing the functional blocks is not particularly limited. That is, the functional blocks may be implemented by one physically and/or logically coupled apparatus. Two or more physically and/or logically separated apparatuses may be directly and/or indirectly (for example, via wires and/or wirelessly) connected, and the plurality of apparatuses may implement the functional blocks.

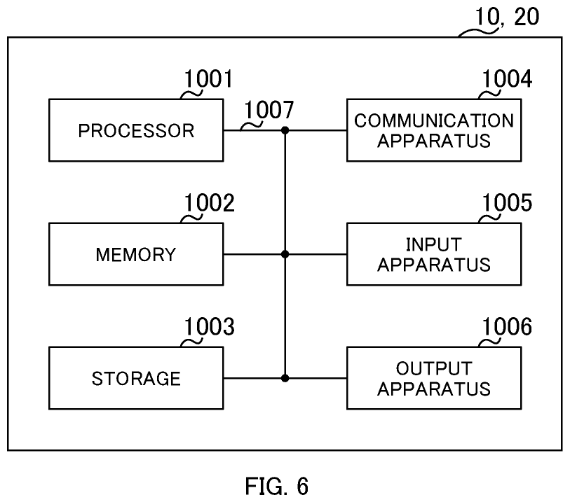

For example, the radio base station 10, the user terminal 20, and the like according to an embodiment of the present invention may function as a computer that executes processing of a radio communication method of the present invention. FIG. 6 illustrates an example of a hardware configuration of the radio base station 10 and the user terminal 20 according to an embodiment. Radio base station 10 and user terminal 20 as described above may be physically constituted as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of radio base station 10 and of user terminal 20 may include one apparatus or a plurality of apparatuses illustrated in the drawings or may not include part of the apparatuses.

For example, although only one processor 1001 is illustrated, there may be a plurality of processors. The processing may be executed by one processor, or the processing may be executed by one or more processors at the same time, in succession, or in another manner. Note that processor 1001 may be implemented by one or more chips.

The functions in radio base station 10 and user terminal 20 are implemented by predetermined software (program) loaded into hardware, such as processor 1001, memory 1002, and the like, according to which processor 1001 performs the arithmetic and controls communication performed by communication apparatus 1004 or reading and/or writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, scheduler 101, transmission signal generation sections 102 and 206, coding and modulation sections 103 and 207, mapping sections 104 and 208, control sections 108 and 203, channel estimation sections 109 and 204, demodulation and decoding sections 110 and 205, and the like as described above may be implemented by processor 1001.

Processor 1001 reads out a program (program code), a software module, or data from storage 1003 and/or communication apparatus 1004 to memory 1002 and executes various types of processing according to the read-out program or the like. The program used is a program for causing the computer to execute at least part of the operation described in the embodiments. For example, scheduler 101 of radio base station 10 may be implemented by a control program stored in memory 1002 and operated by processor 1001, and the other functional blocks may also be implemented in the same way. While it has been described that the various types of processing as described above are executed by one processor 1001, the various types of processing may be executed by two or more processors 1001 at the same time or in succession. Processor 1001 may be implemented by one or more chips. Note that the program may be transmitted from a network through a telecommunication line.

Memory 1002 is a computer-readable recording medium and may be composed of, for example, at least one of a ROM (Read Only Memory), an EPROM (Erasable Programmable ROM), an EEPROM (Electrically Erasable Programmable ROM), and a RAM (Random Access Memory). Memory 1002 may be called a register, a cache, a main memory (main storage apparatus), or the like. Memory 1002 can save a program (program code), a software module, and the like that can be executed to carry out the radio communication method according to an embodiment of the present invention.

Storage 1003 is a computer-readable recording medium and may be composed of, for example, at least one of an optical disk such as a CD-ROM (Compact Disc ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, and a magnetic strip. Storage 1003 may also be called an auxiliary storage apparatus. The storage medium as described above may be a database, server, or other appropriate media including memory 1002 and/or storage 1003.

Communication apparatus 1004 is hardware (transmission and reception device) for communication between computers through a wired and/or wireless network and is also called, for example, a network device, a network controller, a network card, or a communication module. For example, transmission sections 105 and 209, antennas 106 and 201, reception sections 107 and 202, and the like as described above may be implemented by communication apparatus 1004.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which outputs to the outside. Note that input apparatus 1005 and output apparatus 1006 may be integrated (for example, a touch panel).

The apparatuses, such as processor 1001 and memory 1002, are connected by bus 1007 for communication of information. Bus 1007 may be composed of a single bus or by buses different among the apparatuses.

Furthermore, radio base station 10 and user terminal 20 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented by at least one of these pieces of hardware.

(Notification and Signaling of Information)

The notification of information is not limited to the aspects or embodiments described in the present specification, and the information may be notified by another method. For example, the notification of information may be carried out by one or a combination of physical layer signaling (for example, DCI (Downlink Control Information) and UCI (Uplink Control Information)), higher layer signaling (for example, RRC (Radio Resource Control) signaling, MAC (Medium Access Control) signaling, broadcast information (MIB (Master Information Block), and SIB (System Information Block))), and other signals. The RRC signaling may be called an RRC message and may be, for example, an RRC connection setup message, an RRC connection reconfiguration message, or the like.

(Adaptive System)

The aspects and embodiments described in the present specification may be applied to a system using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), or other appropriate systems and/or to a next-generation system extended based on the above systems.

(Processing Procedure and the Like)

The orders of the processing procedures, the sequences, the flow charts, and the like of the aspects and embodiments described in the present specification may be changed as long as there is no contradiction. For example, elements of various steps are presented in exemplary orders in the methods described in the present specification, and the methods are not limited to the presented specific orders.

(Operation of Base Station)

Specific operations which are described in the specification as being performed by the base station (radio base station) may sometimes be performed by an upper node depending on the situation. Various operations performed for communication with a terminal in a network constituted by one network node or a plurality of network nodes including a base station can be obviously performed by the base station and/or a network node other than the base station (examples include, but not limited to, MME (Mobility Management Entity) or S-GW (Serving Gateway)). Although there is one network node in addition to the base station in the case illustrated above, a plurality of other network nodes may be combined (for example, MME and S-GW).

(Direction of Input and Output)

The information, the signals, and the like can be output from a higher layer (or a lower layer) to a lower layer (or a higher layer). The information, the signals, and the like may be input and output through a plurality of network nodes.

(Handling of Input and Output Information and the Like)

The input and output information and the like may be saved in a specific place (for example, memory) or may be managed by a management table. The input and output information and the like can be overwritten, updated, or additionally written. The output information and the like may be deleted. The input information and the like may be transmitted to another apparatus.

(Determination Method)

The determination may be made based on a value expressed by one bit (0 or 1), based on a Boolean value (true or false), or based on comparison with a numerical value (for example, comparison with a predetermined value).

(Software)

Regardless of whether the software is called software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, and the like may be transmitted and received through a transmission medium. For example, when the software is transmitted from a website, a server, or another remote source by using a wired technique, such as a coaxial cable, an optical fiber cable, a twisted pair, and a digital subscriber line (DSL), and/or a wireless technique, such as an infrared ray, a radio wave, and a microwave, the wired technique and/or the wireless technique is included in the definition of the transmission medium.

(Information and Signals)

The information, the signals, and the like described in the present specification may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present specification and/or the terms necessary to understand the present specification may be replaced with terms with the same or similar meaning. For example, the channel and/or the symbol may be a signal. The signal may be a message. The component carrier (CC) may be called a carrier frequency, a cell, or the like.

(“System” and “Network”)

The terms “system” and “network” used in the present specification can be interchangeably used.

(Names of Parameters and Channels)

The information, the parameters, and the like described in the present specification may be expressed by absolute values, by values relative to predetermined values, or by other corresponding information. For example, radio resources may be indicated by indices.

The names used for the parameters are not limited in any respect. Furthermore, the numerical formulas and the like using the parameters may be different from the ones explicitly disclosed in the present specification. Various channels (for example, PUCCH and PDCCH) and information elements (for example, TPC) can be identified by any suitable names, and various names assigned to these various channels and information elements are not limited in any respect.

(Base Station)

The base station (radio base station) can accommodate one cell or a plurality of (for example, three) cells (also called sector). When the base station accommodates a plurality of cells, the entire coverage area of the base station can be divided into a plurality of smaller areas, and each of the smaller areas can provide a communication service based on a base station subsystem (for example, small base station for indoor, remote radio head (RRH)). The term “cell” or “sector” denotes part or all of the coverage area of the base station and/or of the base station subsystem that perform the communication service in the coverage. Furthermore, the terms “base station,” “eNB,” “gNB,” “cell,” and “sector” can be interchangeably used in the present specification. The base station may be called a fixed station, a NodeB, an eNodeB (eNB), gNodeB (gNB), an access point, a femto cell, a small cell, or the like.

(Terminal)

The user terminal may be called, by those skilled in the art, a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or UE (User Equipment) or by some other appropriate terms.

(Meaning and Interpretation of Terms)

As used herein, the term “determining” may encompass a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. When the terms are used in the present specification, two elements can be considered to be “connected” or “coupled” to each other by using one or more electrical wires, cables, and/or printed electrical connections or by using electromagnetic energy, such as electromagnetic energy with a wavelength of a radio frequency domain, a microwave domain, or an optical (both visible and invisible) domain that are non-limiting and non-inclusive examples.

The reference signal can also be abbreviated as RS and may also be called a pilot depending on the applied standard. Further, the DMRS may be called by other corresponding names such as a demodulation RS, a DM-RS, or the like.

The description “based on” used in the present specification does not mean “based only on,” unless otherwise specifically stated. In other words, the description “based on” means both of “based only on” and “based at least on.”

The “section” in the configuration of each apparatus may be replaced with “means,” “circuit,” “device,” or the like.

The terms “including,” “comprising,” and modifications of these terms are intended to be inclusive just like the term “having,” as long as the terms are used in the present specification or the appended claims. Furthermore, the term “or” used in the present specification or the appended claims is not intended to be an exclusive or.

The radio frame may be constituted by one frame or a plurality of frames in the time domain. The one frame or each of the plurality of frames may be called a subframe, a time unit, or the like in the time domain. The subframe may be further constituted by one slot or a plurality of slots in the time domain. The slot may be further constituted by one symbol or a plurality of symbols (OFDM (Orthogonal Frequency Division Multiplexing) symbol, SC-FDMA (Single Carrier-Frequency Division Multiple Access) symbol, or the like) in the time domain.

The radio frame, the subframe, the slot, and the symbol indicate time units in transmitting signals. The radio frame, the subframe, the slot, and the symbol may be called by other corresponding names.

For example, in the LTE system, the base station creates a schedule for assigning radio resources to each mobile station (such as frequency bandwidth that can be used by each mobile station and transmission power). The minimum time unit of scheduling may be called a TTI (Transmission Time Interval).

For example, one subframe, a plurality of continuous subframes, or one slot may be called a TTI.

The resource unit is a resource assignment unit in the time domain and the frequency domain, and the resource unit may include one subcarrier or a plurality of continuous subcarriers in the frequency domain. In addition, the resource unit may include one symbol or a plurality of symbols in the time domain, and may have a length of one slot, one subframe, or one TTI. One TTI and one subframe may be constituted by one resource unit or a plurality of resource units. The resource unit may be called a resource block (RB), a physical resource block (PRB: Physical RB), a PRB pair, an RB pair, a scheduling unit, a frequency unit, or a subband. The resource unit may be constituted by one RE or a plurality of REs. For example, one RE only has to be a resource smaller in unit size than the resource unit serving as a resource assignment unit (for example, one RE only has to be a minimum unit of resource), and the naming is not limited to RE.

The structure of the radio frame is illustrative only, and the number of subframes included in the radio frame, the number of slots included in the subframe, the numbers of symbols and resource blocks included in the slot, and the number of subcarriers included in the resource block can be changed in various ways.

When articles, such as “a,” “an,” and “the” in English, are added by translation in the entire disclosure, the articles include plural forms unless otherwise clearly indicated by the context.

(Variations and the Like of Aspects)

The aspects and embodiments described in the present specification may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While an embodiment of the present invention has been described, it is obvious to those skilled in the art that the present invention is not limited to the embodiments described in the present specification. Modifications and variations of the aspects of the present invention can be made without departing from the spirit and the scope of the present invention defined by the description of the appended claims. Therefore, the description of the present specification is intended for exemplary description and does not limit the present invention in any sense.

### INDUSTRIAL APPLICABILITY

An aspect of the present invention is useful for a mobile communication system.

### REFERENCE SIGNS LIST

10 Radio Base Station
20 User Terminal
101 Scheduler
102, 206 Transmission Signal Generation Section
103, 207 Coding and Modulation Section
104, 208 Mapping Section
105, 209 Transmission Section
106, 201 Antenna
107, 202 Reception Section
108, 203 Control Section
109, 204 Channel Estimation Section
110, 205 Demodulation and Decoding Section

1. A radio transmission apparatus, comprising:
a transmission section that transmits a radio link signal; and
a control section that controls whether to map a phase variation correction reference signal to the radio link signal or controls a mapping interval of the phase variation correction reference signal in the radio link signal, based on a time length or a type of a resource allocation unit.

2. The radio transmission apparatus according to claim 1, wherein
the control section performs control to map the phase variation correction reference signal when the time length of the resource allocation unit is equal to or greater than a threshold, and not to map the phase variation correction reference signal when the time length of the resource allocation unit is lower than the threshold, or
the control section performs control to make the mapping interval of the phase variation correction reference signal stepwisely denser as the time length of the resource allocation unit increases.

3. The radio transmission apparatus according to claim 1, wherein the control section performs control to map the phase variation correction reference signal when the resource allocation unit is of a Slot-based type, and not to map the phase variation correction reference signal when the resource allocation unit is of a Non-slot-based type.

4. A ratio reception apparatus, comprising:
a reception section that receives a radio link signal;
a channel estimation section that performs channel estimation with use of a demodulation reference signal and a phase variation correction reference signal included in the radio link signal; and
a demodulation section that demodulates a data signal included in the radio link signal with use of a result of the channel estimation, wherein
presence or absence of or a mapping interval of the phase variation correction reference signal is determined based on a time length or a type of a resource allocation unit.

5. The radio reception apparatus according to claim 4, wherein
the phase variation correction reference signal is mapped to the radio link signal when the time length of the resource allocation unit is equal to or greater than a threshold and is not mapped to the radio link signal when the time length of the resource allocation unit is lower than the threshold, or
the phase variation correction reference signal is mapped to make the mapping interval stepwisely denser as the time length of the resource allocation unit increases.

6. The radio reception apparatus according to claim 4, wherein the phase variation correction reference signal is mapped to the radio link signal when the resource allocation unit is of a Slot-based type, and is not mapped to the radio link signal when the resource allocation unit is of a Non-slot-based type.
